(19) United States
(12) Patent Application Publication
(10) Pub. No.: US 2021/0147015 A1
(43) Pub. Date: May 20, 2021

(54) METHODS, APPARATUSES, AND DEVICES FOR PROVIDING TRACTION TO A TRACKED VEHICLE

(71) Applicant: John Blanchard, Blanchard, ID (US)

(72) Inventor: John Blanchard, Blanchard, ID (US)

(21) Appl. No.: 17/094,352

(22) Filed: Nov. 10, 2020

Related U.S. Application Data
(60) Provisional application No. 62/935,786, filed on Nov. 15, 2019.

(51) Int. Cl. B62D 55/28

(52) U.S. Cl. CPC B62D 55/283

(57) ABSTRACT

Disclosed herein is a traction device for providing traction to a tracked vehicle, in accordance with some embodiments. Accordingly, the traction device comprises a grouser bar, a down plate, a bottom plate, a pressure plate, and a bolt. Further, the grouser bar comprises a traction element comprised in a top surface of the grouser bar. Further, the traction element is configured to interface with a surface for providing traction for the track on the surface. Further, the down plate is attached to the grouser bar. Further, the bottom plate is attached to the down plate. Further, the pressure plate is movably disposed between the grouser bar and the bottom plate. Further, the bolt is movably coupled with the pressure plate. Further, the bolt is configured for moving the pressure plate between positions in relation to the bottom plate based on an action receivable on a second end of the bolt.

The current application claims a priority to the U.S. Provisional Patent application Ser. No. 62/935,786 filed on Nov. 15, 2019.

### FIELD OF THE INVENTION

Generally, the present disclosure relates to the field of wheel substitutes for land vehicles. More specifically, the present disclosure relates to methods, apparatuses, and devices for providing traction to a tracked vehicle.

### BACKGROUND OF THE INVENTION

Weather events such as rain, snow, and ice dramatically affect the stopping distance of a vehicle. The driver's capability to complete a smooth and safe stop is severely limited due to reduced track plate traction. In order to stop safely, the vehicle's continuous rubber tracks must maintain traction by maintaining a contact with the road surface while rolling. When handling slippery winter roads, the keys to safety are slower speeds, and gentler stops and turns. Currently, there are a number of attempts for solutions to increase the traction of rubber-tracked construction vehicles. Some of these solutions attempt to amalgamate with the OEM rubber tracks with permanent or semi-permanent devices that are not only cumbersome and laborious to rapidly place on and off, but these solutions fail to meet the needs of the industry because using such devices potentially destroy the OEM rubber track, thus the integrity of the steel belts within them. In addition, storing seasonal rubber tracks that weigh upwards of 400 pounds, are cumbersome to move due to their size and mass, create challenges in itself. Other solutions attempt to remedy the issue with drilled in or self-tapping studs for icy surfaces, but these solutions are unable to meet the needs of the industry because they may not accommodate the variables with different terrain surfaces, give the ability to ascend or descend grades and the heads easily shear off with turning on rough surfaces. Still, other solutions seek to recommend winter rubber tracks, but these solutions also fail to meet industry needs because they are extremely costly, laborious to install and uninstall, cumbersome to store, and again do not meet all the needs for multiple surface conditions with the flexibility to rapidly change them when the conditions necessitate it.

Existing techniques for providing traction to a tracked vehicle are deficient with regard to several aspects. For instance, current technologies do not provide an easy and efficient way to increase traction between a track of a vehicle and a road surface. Furthermore, current technologies do not provide a traction device which may be easily stored and readily accessible.

Therefore, there is a need for improved methods, apparatuses, and devices for providing traction to a tracked vehicle that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a traction device for providing traction to a tracked vehicle, in accordance with some embodiments. Accordingly, the traction device may include a grouser bar, a down plate, a bottom plate, a pressure plate, and at least one bolt. Further, the grouser bar may be disposable on at least one track portion of a track of the tracked vehicle. Further, the grouser bar may include at least one traction element comprised in a top surface of the grouser bar. Further, the at least one traction element may be configured to interface with at least one surface for providing traction for the track on the at least one surface. Further, a bottom surface of the grouser bar juxtaposes at least one outer surface of the at least one track portion. Further, the bottom surface opposes the top surface. Further, the down plate may be attached to the grouser bar. Further, a top edge of the down plate may be attached to a butt end of the grouser bar. Further, the down plate extends over a side surface of the track along a depth of the track. Further, the bottom plate may be attached to the down plate. Further, a first edge of the bottom plate may be attached to a bottom edge of the down plate. Further, the bottom plate may be parallel to the grouser bar. Further, the bottom plate may include at least one nut coaxially disposed around at least one hole comprised in the bottom plate. Further, the pressure plate may be movably disposed between the grouser bar and the bottom plate. Further, a superior surface of the pressure plate juxtaposes at least one inner surface of the at least one track portion. Further, the at least one bolt may be threadedly coupled to the at least one nut. Further, the at least one bolt may be movably coupled with the pressure plate. Further, a first end of the at least one bolt interfaces with an inferior surface of the pressure plate. Further, the at least one bolt may be configured for moving the pressure plate between a plurality of positions in relation to the bottom plate based on at least one action receivable on a second end of the at least one bolt. Further, the superior surface presses against the at least one inner surface and the bottom surface presses against the at least one outer surface in at least one first position of the plurality of positions for cinching the at least one track portion between the grouser bar and the pressure plate. Further, the superior surface does not press against the at least one inner surface and the bottom surface does not press against the at least one outer surface in at least one second position of the plurality of positions for not cinching the at least one track portion between the grouser bar and the pressure plate. Further, the traction device attaches to the at least one track portion in the at least one first position. Further, the traction device detaches from the at least one track portion in the at least one second position.

Further disclosed herein is a traction device for providing traction to a tracked vehicle, in accordance with some embodiments. Accordingly, the traction device may include a grouser bar, a down plate, a bottom plate, a pressure plate, and at least one bolt. Further, the grouser bar may be disposable on at least one track portion of a track of the tracked vehicle. Further, the grouser bar may include at least one traction element comprised in a top surface of the grouser bar. Further, the at least one traction element may be configured to interface with at least one surface for providing traction for the track on the at least one surface. Further, a bottom surface of the grouser bar juxtaposes at least one outer surface of the at least one track portion. Further, the bottom surface opposes the top surface. Further, the down plate may be attached to the grouser bar. Further, a top edge of the down plate may be attached to a butt end of the grouser bar. Further, the down plate extends over a side surface of the track along a depth of the track. Further, the bottom plate may be attached to the down plate. Further, a first edge of the bottom plate may be attached to a bottom edge of the down plate. Further, the down plate may be substantially perpendicular to at least one of the grouser bar and the bottom plate. Further, the bottom plate may be parallel to the grouser bar. Further, the bottom plate may include at least one nut coaxially disposed around at least one hole comprised in the bottom plate. Further, the pressure plate may be movably disposed between the grouser bar and the bottom plate. Further, a superior surface of the pressure plate juxtaposes at least one inner surface of the at least one track portion. Further, the pressure plate may be substantially parallel to at least one of the grouser bar and the bottom plate. Further, the pressure plate may be substantially perpendicular to the down plate. Further, the at least one bolt may be threadedly coupled to the at least one nut. Further, the at least one bolt may be movably coupled with the pressure plate. Further, a first end of the at least one bolt interfaces with an inferior surface of the pressure plate. Further, the at least one bolt may be configured for moving the pressure plate between a plurality of positions in relation to the bottom plate based on at least one action receivable on a second end of the at least one bolt. Further, the superior surface presses against the at least one inner surface and the bottom surface presses against the at least one outer surface in at least one first position of the plurality of positions for cinching the at least one track portion between the grouser bar and the pressure plate. Further, the superior surface does not press against the at least one inner surface and the bottom surface does not press against the at least one outer surface in at least one second position of the plurality of positions for not cinching the at least one track portion between the grouser bar and the pressure plate. Further, the traction device attaches to the at least one track portion in the at least one first position. Further, the traction device detaches from the at least one track portion in the at least one second position.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front view of a traction device providing traction to a tracked vehicle, in accordance with some embodiments.

FIG. 2 is a front perspective view of the traction device attached to the at least one track portion of the track, in accordance with some embodiments.

FIG. 3 is a rear perspective view of the traction device attached to the at least one track portion of the track, in accordance with some embodiments.

FIG. 4 is a top view of the traction device attached to the at least one track portion of the track, in accordance with some embodiments.

FIG. 5 is a partial top view of a track of a tracked vehicle with a traction device, in accordance with some embodiments.

FIG. 6 is a partial top perspective view of a track of a tracked vehicle with at least one traction device, in accordance with some embodiments.

FIG. 7 is a partial top perspective view of a track of a tracked vehicle with at least one traction device, in accordance with some embodiments.

FIG. 8 is a partial top perspective view of a track of a tracked vehicle with at least one traction device, in accordance with some embodiments.

FIG. 9 is a perspective view of a tracked vehicle with a plurality of traction devices, in accordance with some embodiments.

FIG. 10 is a front view of a grouser bar of a traction device, in accordance with some embodiments.

FIG. 11 is a front perspective view of the grouser bar of the traction device, in accordance with some embodiments.

FIG. 12 is a side view of a pressure plate of a traction device, in accordance with some embodiments.

FIG. 13 is a rear view of the pressure plate of the traction device, in accordance with some embodiments.

FIG. 14 is a front view of a traction element of a grouser bar of a traction device, in accordance with some embodiments.

FIG. 15 is a front view of a traction element of the grouser bar, in accordance with some embodiments.

FIG. 16 is a front view of a traction element of the grouser bar, in accordance with some embodiments.

FIG. 17 is a front view of a traction device for providing traction to a tracked vehicle, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, apparatuses, and devices for providing traction to a tracked vehicle, embodiments of the present disclosure are not limited to use only in this context.

Overview:

The present disclosure describes methods, apparatuses, and devices for providing traction to a tracked vehicle. Further, the present disclosure describes a traction device configured to be attached to the tracked vehicle for providing traction to the tracked vehicle. Further, the traction device may include a 6″ inch to 9″ inch steel (dependent on track width size) modified grouser bar with a multitude of surface chain/steel paddle bar options welded to its top surface to come into contact with the road or native surface in order to accommodate the slick conditions. Further, steel modified grouser bar on its inferior surface opposite of the road contact side has small ⅛″ inch spikes running down its spine in order to come in contact with the surface valley of the rubber tracks to prevent slippage and/or migration once the traction device may be cinched from below. Further, a modified toothed grouser bar may be welded at its terminal butt end at ninety degrees to a ⅜″ inch by 2″ inch wide by 2 and ⅝″ in length steel plate to the face of its short axis edge that may be descending down the outer rubber track depth. Further, descending steel plate may butt on its short axis edge at a ninety-degree angle to another fixed welded steel plate ⅜″ inch by 2″ inch wide by 3″ inch in length that runs parallel in the same direction as above the modified grouser bar both of which are facing inward and running perpendicular to the continuous rubber track. Further, welded to this bottom plate are 2⅝″ inch steel nuts welded over two holes drilled within the bottom plate to receive 2⅝″ inch steel bolts in order to force a floating pressure plate to the underside of the rubber track. Further, the floating pressure plate may be ⅜″ inch thick steel by 2″ inch wide by 3″ in length with the superior surface that may come in contact with the underside of the rubber tracks has several ⅛″ inch spikes protruding upward in order to sink these teeth within the rubber track to reduce the ability of movement and/or migration; on the flip side or inferior surface, the surface that may be in contact with the bolts, may have two round cylinders slightly larger than ⅝″ in order to receive the bolts to prevent the plate from slipping off to one side or the other while tightening the bolts against the floating plate as it presses into and cinches the rubber track by a sandwiching effect against to top modified grouser bar.

Further, the traction device may include a modified grouser bar/cleat welded to traction chain designed to grip slick surfaces such as ice, snow, or mud that would normally be impassable with standard rubber tracks as seen on construction equipment. The traction device may drastically produce improved ground traction in order to provide safer, secured travel on snow, ice, or mud-covered surfaces of which become dangerous due to lack of traction from rubber tracks alone while simultaneously, lessening vibrations and jolting from the current devices on the market. The traction device can be used on all rubber tracks with the difference being it may be placed within the valleys of the trackpads rather than on the surface tread block thus, creating a smoother ride and reducing vibrations while simultaneously gripping the slick native surface. The core components of the disclosure are ⅜″ solid steel plating structurally forming the traction device with multiple variations and options of snow/ice gripping chain that may come in contact with the ground which may be welded to the steel grouser bar that in turn may be cinched onto the outside wall of the rubber tracks and may transverse across the valley of the track between the tread blocks. The contact surface of the traction device may have welded traction chain and/or steel bars designed to increase traction surface to rise above the rubber tread block gripping the slick surface. Two bolts threaded through welded surface nuts on the opposite parallel underside may compress a ⅜″ corrugated steel plate up to the undersurface of the rubber track cinching the grouser bar lying above it within the valley of the track to form a secured fixed pressed attachment, which, generally speaking, are configured as follows: the steel device may be inserted onto the track with the grouser bar resting within the track valley between the tread block pattern. The compression bolts are then tightened equally causing the steel corrugated plate to cinch and compress the rubber track thus sandwiching it between the grouser bar above and the corrugated steel plate below. With respect to the traction device, it may be further noted that a wide array of different grades of traction chain and/or steel bars range from studded gripping chain to V-bar gripping chain to standard twist-link gripping chain along with steel coped bar paddle to rubber bar paddle with ice studs buried within it, all of which can be implemented to the grouser bar allowing for variable levels of traction thus grip for different surfaces such as concrete, asphalt, dirt and/or gravel without disrupting and/or destroying the native surface. With respect to the associated method, in order to carry out the method the following core steps are followed: the grouser bar can be installed anywhere along the track that may be not in contact with the ground, thus making the installing and uninstalling of the traction device quick, simple and efficient when changes in weather occur abruptly. Ultimately, at the conclusion of these steps, there may be no drilling into or degrading the integrity of the rubber track with studs or permanent cleats therefore, easy on and off of the traction device without the daunting and arduous task of removing and/or replacing the entire rubber tracks or unbolting and removing several hundred studs and/or cleats during the winter months of rain, snow, and ice.

Further, the traction device allows for rapid on and off capabilities on rubber tracks to accommodate intermittent weather changes with rain, snow, and ice conditions which do not require exhausting and laborious changing of studs, cleats, and/or specific snow rubber tracks that may weigh up to 400 and 600 pounds. Furthermore, the traction device may be easy to store and readily accessible to implement without exhaustive onerous labor. Further, the traction device does not cause unnecessary wear and tear through excessive vibrations and jolting from large cumbersome track bars that abruptly raise and lower the machine between each track bar rotation causing extreme jolting up and down along with severe vibrations especially, when traveling down paved or hard-surfaced roads. The disclosed traction device and associated method advantageously fill these need and addresses the aforementioned deficiencies by providing a modified grouser bar with multiple traction capabilities to cinch with ease onto a rubber track to accommodate a multitude of slippery road conditions such as rain, mud, snow and/or ice without laborious labor and effort to modify the OEM rubber tracks.

Further, the modified grouser traction bar cinched onto a continuous rubber track, which may be made up of the following components: 1) a modified grouser bar ⅜″ thick by 1.5″ wide by 9″ inches in length with a welded component i.e. traction chain to its surface. 2) the modified grouser bar may be welded perpendicular at its butt end onto the top facing short-axis edge of a ⅜″ inch thick by 2″ wide steel plate that runs down at a 90-degree angle or perpendicular from the grouser bar. This steel flat bar may be 2″ inches wide by 2 and ⅝″ inches in length and may terminate on edge at another 90-degree angle. 3) the bottom steel ⅜″ plate that may be 3″ inches in length and runs parallel and in the same direction as to the above grouser bar. 4) two steel ⅝″ nuts welded the outside inferior portion of the steel plate in order to receive two steel ⅝″ bolts. 5) these 2 bolts threaded through the nuts may press a corrugated steel plate that may be ⅜″ thick by 2″ wide and 3″ in length upwardly to sandwich the rubber track between the upper modified grouser bar on the surface of the track to the parallel plate below on the underside of the rubber track. These components are welded together as follows: the inferior steel plate may be welded on edge at a ninety-degree angle to the rising plate that extends upward to hold the grouser bar that also may be welded at a 90-degree angle on edge and sits within the valley of the track. The modified grouser bar may have the option of several different types of traction control chains, rubber tread with studs, and/or steel traction paddle bars welded to the parallel grouser bar. The inferior or bottom plate has two nuts welded to the base plate that receive two steel ⅝″ inch bolts that press the steel pressure plate to the rubber track causing a sandwich effect to the rubber track securing the traction device in place.

Further, the traction device may also have one or more of the following: variable styles of snow/ice traction chain, rubber paddle bars with inserted studs as well as steel coved and/or chevron style paddle bars. For example, the chain variables may include studded chain, v-bar chain, simple twisted and square chain, solid steel straight bar, and chevron pattern steel bar all of which are designed for varying grip effects to gain better traction on different types of slick muddy, icy or snow-covered surfaces conditions such as concrete, asphalt, compact dirt, gravel and the like. Similarly, the associated method may also include one or more of the following steps: the number of devices placed per rubber track can be to the operators comfort level as well as the severity of terrain from as little as 6 devises per rubber track to as many that may fit within all the valleys between the tread pattern of the track to effectively grip the terrain surface.

Further, the traction device may be made up of the following components: 1) a 6″ inch to 9″ inch steel (dependent on track width size) modified grouser bar with a multitude of surface chain/steel paddle bar options welded to its top surface to come into contact with the road or native surface in order to accommodate the slick conditions. 2) this steel modified grouser bar on its inferior surface opposite of the road contact side, has small ⅛″ inch spikes running down its spine in order to come in contact with the surface valley of the rubber tracks to prevent slippage and/or migration once the traction device may be cinched from below. 3) this modified toothed grouser bar may be welded at its terminal butt end at ninety degrees to a ⅜″ inch by 2″ inch wide by 2 and ⅝″ in length steel plate to the face of its short axis edge that may be descending down the outer rubber track depth. 4) this descending steel plate may butt on its short axis edge at a ninety-degree angle to another fixed welded steel plate ⅜″ inch by 2″ inch wide by 3″ inch in length that runs parallel in the same direction as above the modified grouser bar both of which are facing inward and running perpendicular to the continuous rubber track. 5) welded to this bottom plate are 2⅝″ inch steel nuts welded over two holes drilled within the bottom plate to receive 2⅝″ inch steel bolts in order to force the floating pressure plate to the underside of the rubber track. 6) the floating pressure plate may be ⅜″ inch thick steel by 2″ inch wide by 3″ in length with the superior surface that may come in contact with the underside of the rubber tracks has several ⅛″ inch spikes protruding upward in order to sink these teeth within the rubber track to reduce the ability of movement and/or migration; on the flip side or inferior surface, the surface that may be in contact with the bolts, may have two round cylinders slightly larger than ⅝″ in order to receive the bolts to prevent the plate from slipping off to one side or the other while tightening the bolts against the floating plate as it presses into and cinches the rubber track by a sandwiching effect against to top modified grouser bar. These components are all connected utilizing structural welds as described above. Further, the underside of the grouser bar as well as the superior surface side of the pressure plate are toothed or spiked in order to grip the rubber track to prevent migration or slippage of the traction device while under the torque of the machine.

Further, the present disclosure describes a method for applying the traction device to the track of tracked construction vehicles for providing traction to the tracked construction vehicles. Further, the method may include the following steps: 1) remove and clean off excess mud or debris from the valleys of the tracks where the traction device may be placed. 2) slide the traction device into the valley until the traction device butts against the rubber tracks stopping at the steel descending down plate. 3) begin to equally tighten the 2⅝″ inch bolts against the pressure plate lining the bolts into the 2 receiving round cylinders to prevent the floating pressure plate from moving or migrating side to side. 4) continue to tighten the floating pressure plate into the rubber track until the two bolts are completely tightened to their endpoints to the fixed welded nuts. Further, lock-tight thread control gel may be placed on all threads prior to torquing down the bolts and the traction device may not intend to be used for extreme demolition of uneven surfaces such as demolished uneven concrete, rebar, asphalt chunks, and/or building materials that could potentially wedge and pry off the device, thus damaging not only the device but also the OEM rubber tracks.

The disclosed traction device may be unique when compared with other known devices and solutions because it provides (1) rapid on and off application; (2) multiple variables for different terrain options; and (3) ease of storage. Similarly, the associated method may be unique in that it: (1) reduces wear and tear on the machine; (2) less impact of vibrations and jolting on the operator; and (3) can be installed rapidly without extensive tools, lifts, jacks or manpower resources.

Similarly, the disclosed method may be unique when compared with other known processes and solutions in that it (1) can be transported easily due to their compact size; (2) only require a socket wrench to install and uninstall; and (3) require no alterations to the OEM tracks.

The disclosed traction device may be unique in that it may be structurally different from other known devices or solutions. More specifically, the traction device may be unique due to the presence of (1) low vibration; (2) smooth ride for operator comfort; and (3) no ongoing maintenance.

Furthermore, the process associated with the aforementioned device may be likewise unique. More specifically, the disclosed process owes its uniqueness to the fact that it (1) requires no drilling or permanency; (2) no laborious manpower to install and/or remove; and (3) does not require ample space to store when not in use.

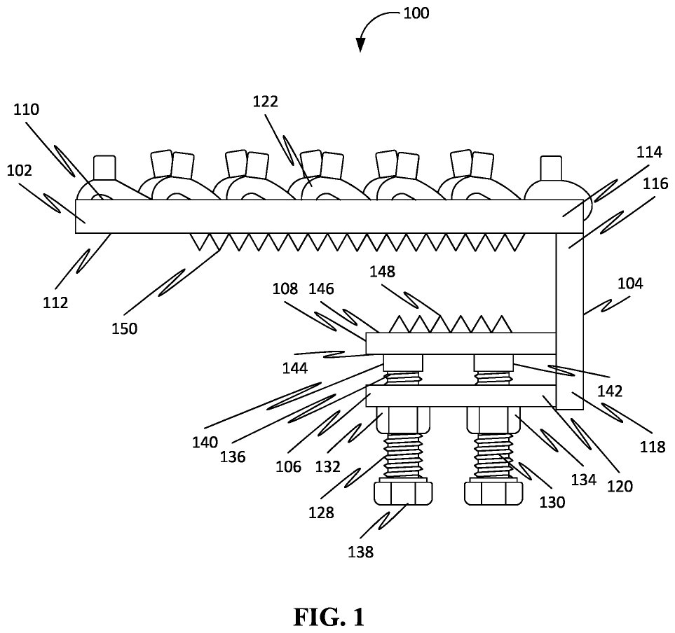

FIG. 1 is a front view of a traction device 100 providing traction to a tracked vehicle (such as a tracked vehicle 900), in accordance with some embodiments. Further, the traction device 100 may include a grouser bar 102, a down plate 104, a bottom plate 106, a pressure plate 108, and at least one bolt 128-130. Further, the tracked vehicle may include a tracked construction vehicle, a rubber-tracked construction vehicle, etc.

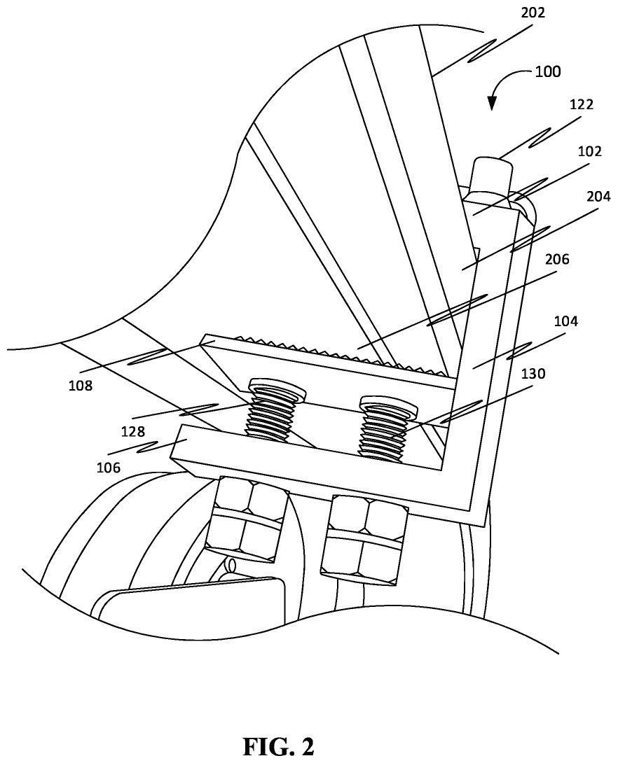

Further, the grouser bar 102 may be disposable on at least one track portion 204, as shown in FIG. 2, of a track 202 of the tracked vehicle. Further, the grouser bar 102 may include at least one traction element 122 comprised in a top surface 110 of the grouser bar 102. Further, the at least one traction element 122 may be configured to interface with at least one surface for providing traction for the track 202 on the at least one surface. Further, the at least one surface may include a ground surface. Further, a bottom surface 112 of the grouser bar 102 juxtaposes at least one outer surface of the at least one track portion 204. Further, the bottom surface 112 opposes the top surface 110.

Further, the down plate 104 may be attached to the grouser bar 102. Further, a top edge 116 of the down plate 104 may be attached to a butt end 114 of the grouser bar 102. Further, the down plate 104 extends over a side surface of the track 202 along a depth of the track.

Further, the bottom plate 106 may be attached to the down plate 104. Further, a first edge 120 of the bottom plate 106 may be attached to a bottom edge 118 of the down plate 104. Further, the bottom plate 106 may be parallel to the grouser bar 102. Further, the bottom plate 106 may include at least one nut 132-134 coaxially disposed around at least one hole comprised in the bottom plate 106.

Further, the pressure plate 108 may be movably disposed between the grouser bar 102 and the bottom plate 106. Further, a superior surface 146 of the pressure plate 108 juxtaposes at least one inner surface 206 of the at least one track portion 204.

Further, the at least one bolt 128-130 may be threadedly coupled to the at least one nut 132-134. Further, the at least one bolt 128-130 may be movably coupled with the pressure plate 108. Further, a first end 136 of the at least one bolt 128-130 interfaces with an inferior surface 144 of the pressure plate 108. Further, the at least one bolt 128-130 may be configured for moving the pressure plate 108 between a plurality of positions in relation to the bottom plate 106 based on at least one action receivable on a second end 138 of the at least one bolt 128-130. Further, the superior surface 146 presses against the at least one inner surface 206 and the bottom surface 112 presses against the at least one outer surface in at least one first position of the plurality of positions for cinching the at least one track portion 204 between the grouser bar 102 and the pressure plate 108. Further, the superior surface 146 does not press against the at least one inner surface 206 and the bottom surface 112 does not press against the at least one outer surface in at least one second position of the plurality of positions for not cinching the at least one track portion 204 between the grouser bar 102 and the pressure plate 108. Further, the traction device 100 attaches to the at least one track portion 204 in the at least one first position. Further, the traction device 100 detaches from the at least one track portion 204 in the at least one second position.

Further, in some embodiments, the track 202 may include a plurality of tread blocks disposed on a track outer surface of the track 202 in at least one tread pattern forming at least one valley. Further, the at least one valley may include the at least one track portion 204. Further, the grouser bar 102 may be disposable on the at least one valley. Further, in an embodiment, the track outer surface forms the at least one outer surface of the at least one track portion 204 based on the at least one tread pattern. Further, the plurality of tread blocks may include a plurality of tread outer surfaces. Further, at least one tread outer surface of the plurality of tread outer surfaces interfaces with the at least one surface. Further, the at least one outer surface does not interface the at least one surface.

Further, in some embodiments, the at least one traction element 122 may include at least one of at least one traction chain and at least one paddle bar. Further, the at least one of the at least one traction chain and the at least one paddle bar may be configured for providing at least one level of the traction for the track 202 on the at least one surface. Further, the at least one traction element 122 may include at least one snow/ice traction chain, at least one rubber paddle bar with inserted studs, at least one steel coved and/or chevron style paddle bar. Further, the at least one traction element 122 may include at least one chain. Further, the at least one chain may include a studded chain, a v-bar chain, a simple twisted chain, a square chain, etc. Further, the at least one traction element 122 may include a solid steel straight bar, a chevron pattern steel bar, etc.

Further, in some embodiments, the down plate 104 may be substantially perpendicular to at least one of the grouser bar 102 and the bottom plate 106.

Further, in some embodiments, the pressure plate 108 may be substantially parallel to at least one of the grouser bar 102 and the bottom plate 106. Further, the pressure plate 108 may be substantially perpendicular to the down plate 104.

Further, in some embodiments, the grouser bar 102 may include at least one protrusion 150 disposed on the bottom surface 112. Further, the at least one protrusion 150 configured for interfacing with the at least one outer surface of the at least one track portion 204 based on the cinching of the at least one track portion 204 between the grouser bar 102 and the pressure plate 108. Further, the at least one protrusion 150 prevents at least one relative movement between the grouser bar 102 and the at least one track portion 204 based on the interfacing. Further, the at least one protrusion 150 may include at least one spike.

Further, in some embodiments, the pressure plate 108 may include at least one first protrusion 148 disposed on the superior surface 146. Further, the at least one first protrusion 148 configured for interfacing with the at least one inner surface 206 of the at least one track portion 204 based on the cinching of the at least one track portion 204 between the grouser bar 102 and the pressure plate 108. Further, the at least one first protrusion 148 prevents at least one relative movement between the pressure plate 108 and the at least one track portion 204 based on the interfacing. Further, the at least one first protrusion 148 may include at least one spike.

Further, in some embodiments, the pressure plate 108 may include at least one hollow cylinder 140-142 disposed on the inferior surface 144. Further, the at least one hollow cylinder 140-142 may be configured for receiving a first portion of the at least one bolt 128-130 in an interior space of the at least one hollow cylinder 140-142 through an opening of the at least one hollow cylinder 140-142. Further, the first end 136 of the at least one bolt 128-130 interfaces with the inferior surface 144 based on the receiving. Further, in an embodiment, the pressure plate 108 moves between the plurality of positions in at least one orientation in relation to at least one of the bottom plate 106 and the grouser bar 102 based on the receiving.

Further, in some embodiments, the at least one bolt 128-130 may be configured for translationally moving along an axis perpendicular to at least one of the bottom plate 106 and the grouser bar 102 in relation to the bottom plate 106 based on the at least one action receivable on the second end 138. Further, in an embodiment, the pressure plate 108 moves between the plurality of positions along a first axis perpendicular to the pressure plate 108 based on the translationally moving. Further, the first axis may be parallel to the axis.

Further, in some embodiments, the at least one bolt 128-130 may be at least one moving mechanism. Further, the at least one moving mechanism may be movably coupled with the pressure plate 108. Further, the at least one moving mechanism may be configured for moving the pressure plate 108 between the plurality of positions in relation to the bottom plate 106.

Further, in some embodiments, the pressure plate 108 may be movably attached to a first side of the down plate 104. Further, the pressure plate 108 moves between the plurality of positions along the down plate 104 between the top edge 116 and the bottom edge 118.

Further, in some embodiments, the down plate 104 may be detachably attached to at least one of the grouser bar 102 and the bottom plate 106 using at least one attaching mechanism comprised in at least one of the top edge 116 and the bottom edge 118. Further, the at least one attachment mechanism may be configured for removably securing at least one of the butt end 114 and the first edge 120.

FIG. 2 is a front perspective view of the traction device 100 attached to the at least one track portion 204 of the track 202, in accordance with some embodiments.

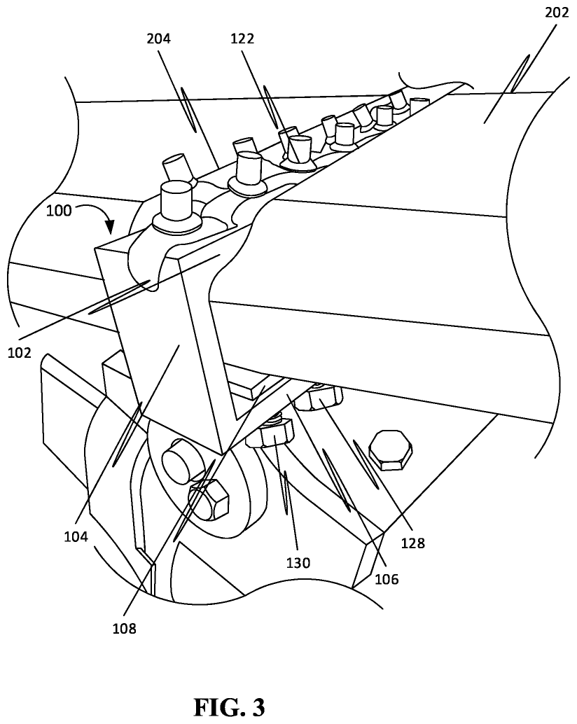

FIG. 3 is a rear perspective view of the traction device 100 attached to the at least one track portion 204 of the track 202, in accordance with some embodiments.

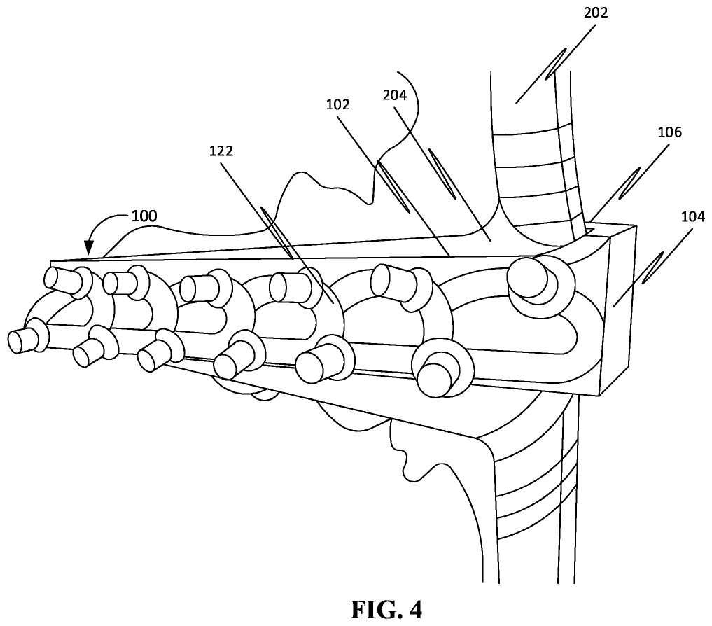

FIG. 4 is a top view of the traction device 100 attached to the at least one track portion 204 of the track 202, in accordance with some embodiments.

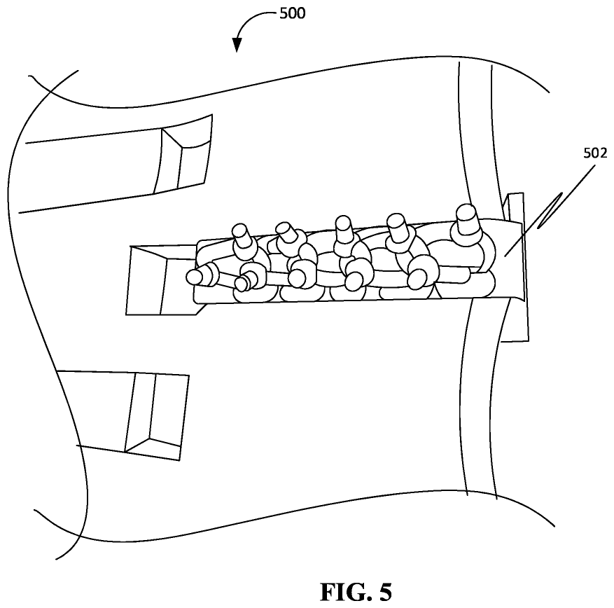

FIG. 5 is a partial top view of a track 500 of a tracked vehicle with a traction device 502, in accordance with some embodiments. Further, the track 500 may include an OEM rubber track. Further, the traction device 502 may be removably attached to at least one portion of the track 500.

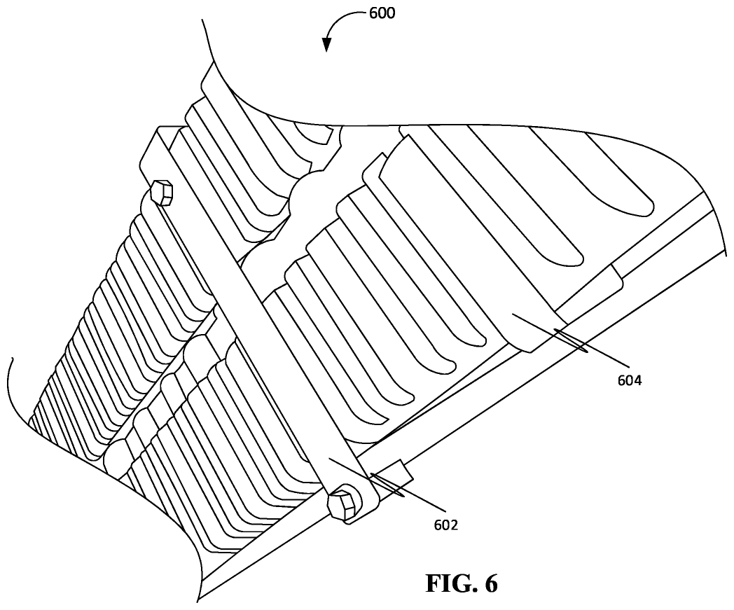

FIG. 6 is a partial top perspective view of a track 600 of a tracked vehicle with at least one traction device 602-604, in accordance with some embodiments. Further, the at least one traction device 602-604 may be removably attached to at least one portion of the track 600.

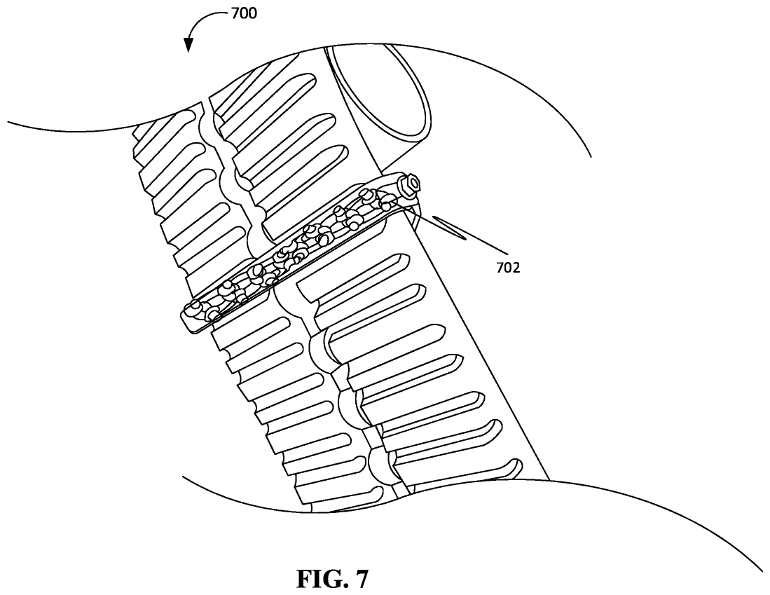

FIG. 7 is a partial top perspective view of a track 700 of a tracked vehicle with at least one traction device 702, in accordance with some embodiments. Further, the at least one traction device 702 may be removably attached to at least one portion of the track 700.

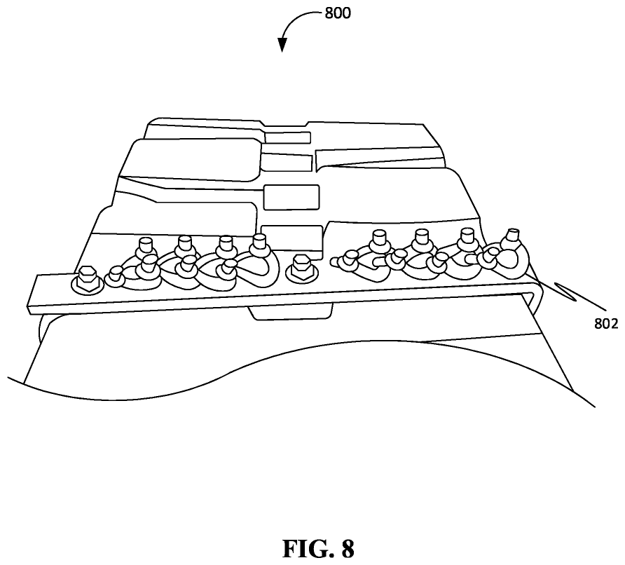

FIG. 8 is a partial top perspective view of a track 800 of a tracked vehicle with at least one traction device 802, in accordance with some embodiments. Further, the at least one traction device 802 may be removably attached to at least one portion of the track 800.

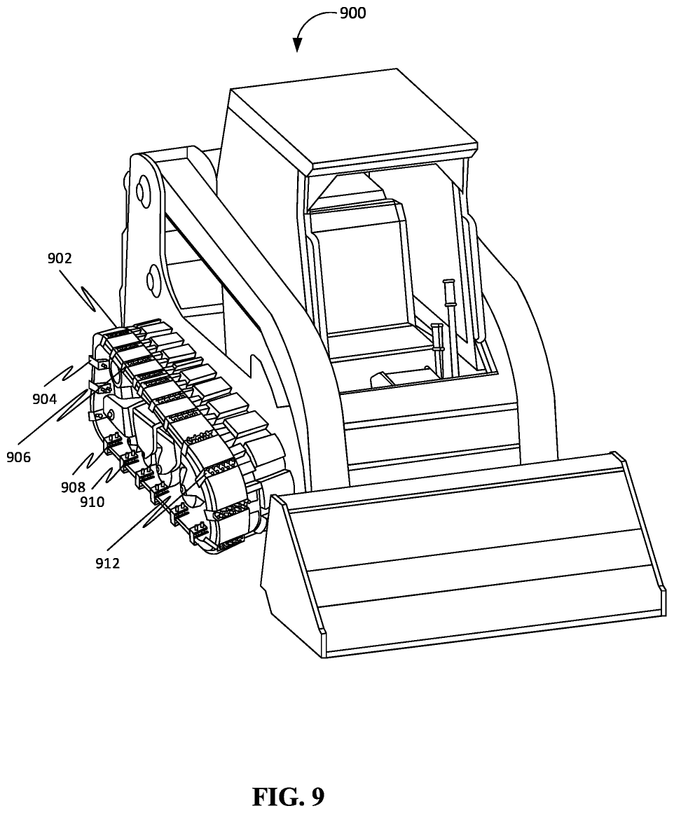

FIG. 9 is a perspective view of a tracked vehicle 900 with a plurality of traction devices 904-912, in accordance with some embodiments. Further, the plurality of traction devices 904-912 may be attached to a plurality of track portions of a track 902 of the tracked vehicle 900.

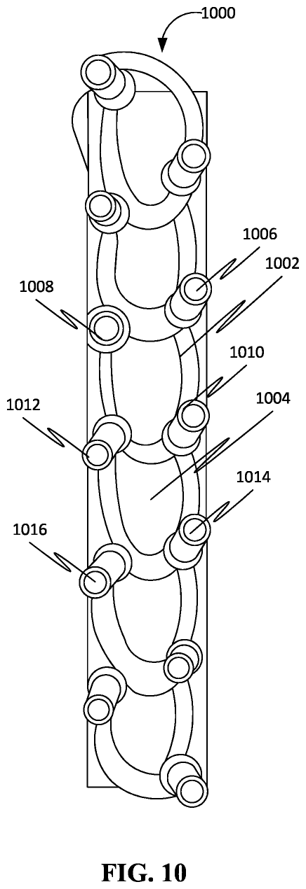

FIG. 10 is a front view of a grouser bar 1000 of a traction device, in accordance with some embodiments. Further, the grouser bar 1000 may include at least one traction element 1002 comprised in a top surface 1004 of the grouser bar 1000. Further, the at least one traction element 1002 may be welded on to the top surface 1004. Further, the at least one traction element 1002 may include at least one traction protrusion 1006-1016. Further, the at least one traction protrusion 1006-1016 may form at least one stud.

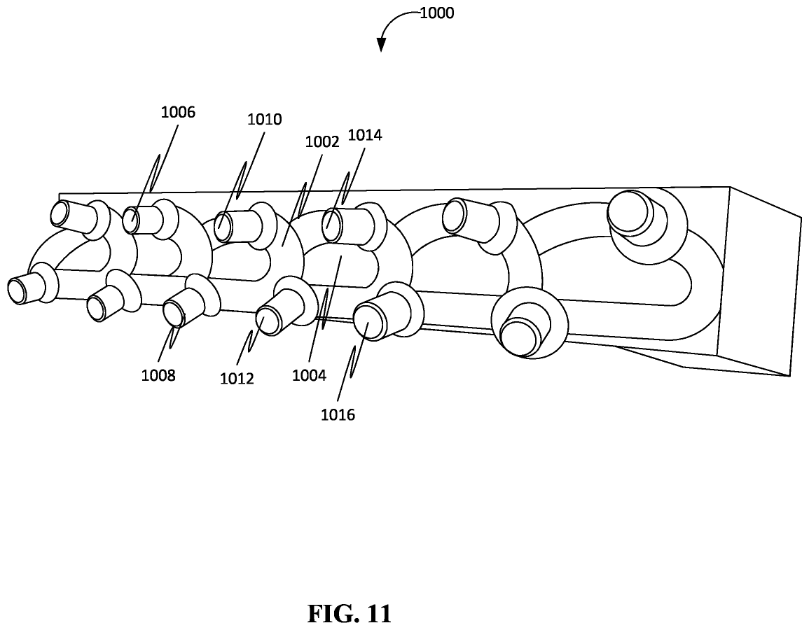

FIG. 11 is a front perspective view of the grouser bar 1000 of the traction device, in accordance with some embodiments.

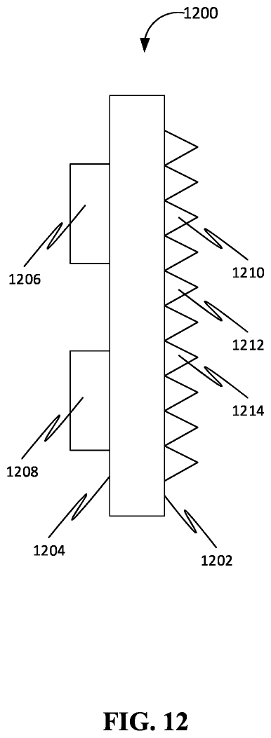

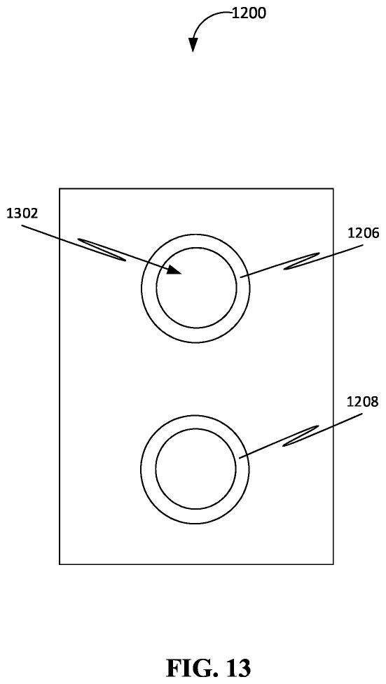

FIG. 12 is a side view of a pressure plate 1200 of a traction device, in accordance with some embodiments. Further, the pressure plate 1200 may include a superior surface 1202 and an inferior surface 1204. Further, the pressure plate 1200 may include at least one spike 1210-1214 disposed on the superior surface 1202. Further, the at least one spike 1210-1214 may be attached to the superior surface 1202. Further, the pressure plate 1200 may include at least one cylinder 1206-1208 disposed on the inferior surface 1204. Further, the at least one cylinder 1206-1208 may be attached to the inferior surface 1204. Further, the at least one cylinder 1206-1208 may include an interior space 1302, as shown in FIG. 13, and an opening leading into the interior space 1302.

FIG. 13 is a rear view of the pressure plate 1200 of the traction device, in accordance with some embodiments.

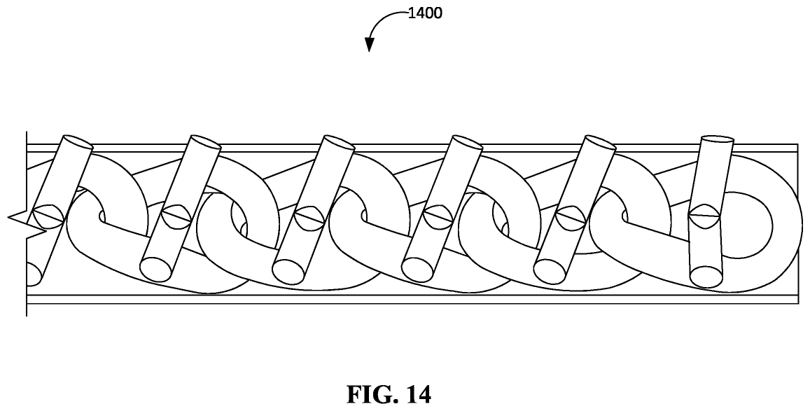

FIG. 14 is a front view of a traction element 1400 of a grouser bar of a traction device, in accordance with some embodiments. Further, the traction element 1400 may include a V-link gripping chain. Further, the traction element 1400 may include at least one stud. Further, the at least one stud may be welded to the traction element 1400. Further, the at least one stud may protrude from the traction element 1400.

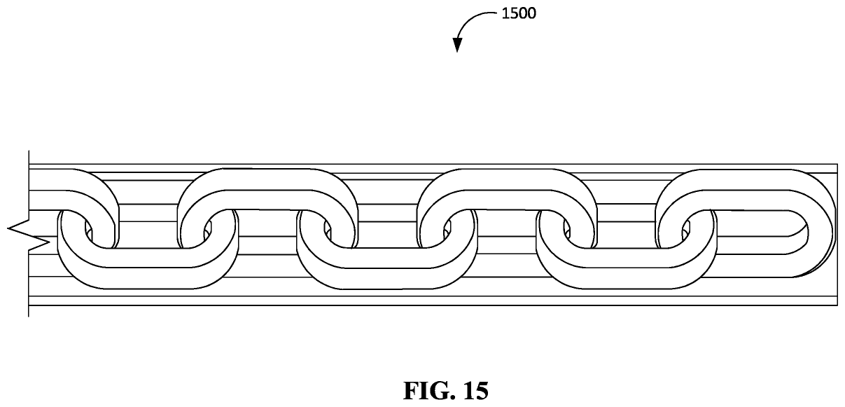

FIG. 15 is a front view of a traction element 1500 of the grouser bar, in accordance with some embodiments. Further, the traction element 1500 may include a square-link gripping chain.

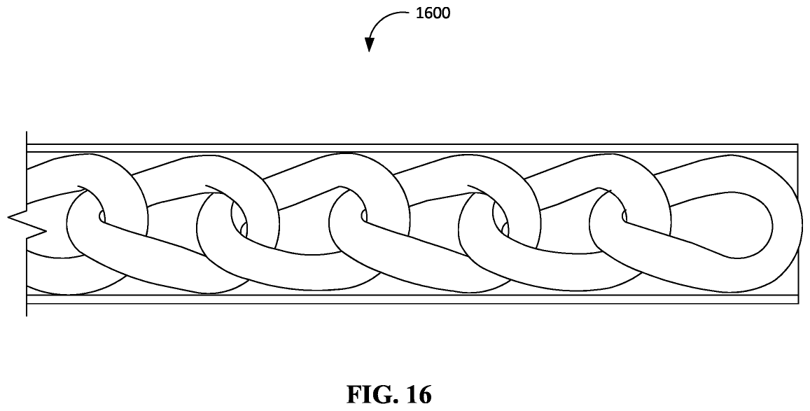

FIG. 16 is a front view of a traction element 1600 of the grouser bar, in accordance with some embodiments. Further, the traction element 1600 may include a twisted-link gripping chain.

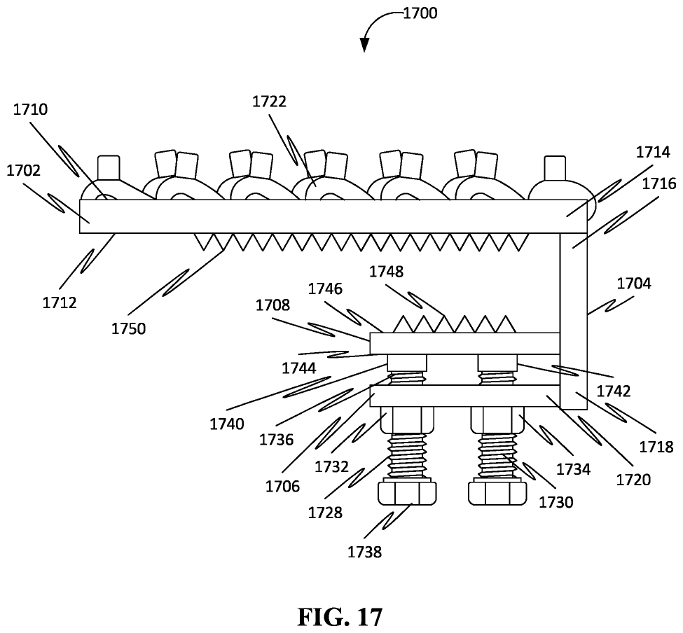

FIG. 17 is a front view of a traction device 1700 for providing traction to a tracked vehicle, in accordance with some embodiments. Further, the traction device 1700 may include a grouser bar 1702, a down plate 1704, a bottom plate 1706, a pressure plate 1708, and at least one bolt 1728-1730.

Further, the grouser bar 1702 may be disposable on at least one track portion of a track of the tracked vehicle. Further, the grouser bar 1702 may include at least one traction element 1722 comprised in a top surface 1710 of the grouser bar 1702. Further, the at least one traction element 1722 may be configured to interface with at least one surface for providing traction for the track on the at least one surface. Further, a bottom surface 1712 of the grouser bar 1702 juxtaposes at least one outer surface of the at least one track portion. Further, the bottom surface 1712 opposes the top surface 1710.

Further, the down plate 1704 may be attached to the grouser bar 1702. Further, a top edge 1716 of the down plate 1704 may be attached to a butt end 1714 of the grouser bar 1702. Further, the down plate 1704 extends over a side surface of the track along a depth of the track.

Further, the bottom plate 1706 may be attached to the down plate 1704. Further, a first edge 1720 of the bottom plate 1706 may be attached to a bottom edge 1718 of the down plate 1704. Further, the down plate 1704 may be substantially perpendicular to at least one of the grouser bar 1702 and the bottom plate 1706. Further, the bottom plate 1706 may be parallel to the grouser bar 1702. Further, the bottom plate 1706 may include at least one nut 1732-1734 coaxially disposed around at least one hole comprised in the bottom plate 1706.

Further, the pressure plate 1708 may be movably disposed between the grouser bar 1702 and the bottom plate 1706. Further, a superior surface 1746 of the pressure plate 1708 juxtaposes at least one inner surface of the at least one track portion. Further, the pressure plate 1708 may be substantially parallel to at least one of the grouser bar 1702 and the bottom plate 1706. Further, the pressure plate 1708 may be substantially perpendicular to the down plate 1704.

Further, the at least one bolt 1728-1730 may be threadedly coupled to the at least one nut 1732-1734. Further, the at least one bolt 1728-1730 may be movably coupled with the pressure plate 1708. Further, a first end 1736 of the at least one bolt 1728-1730 interfaces with an inferior surface 1744 of the pressure plate 1708. Further, the at least one bolt 1728-1730 may be configured for moving the pressure plate 1708 between a plurality of positions in relation to the bottom plate 1706 based on at least one action receivable on a second end 1738 of the at least one bolt 1728-1730. Further, the superior surface 1746 presses against the at least one inner surface and the bottom surface 1712 presses against the at least one outer surface in at least one first position of the plurality of positions for cinching the at least one track portion between the grouser bar 1702 and the pressure plate 1708. Further, the superior surface 1746 does not press against the at least one inner surface and the bottom surface 1712 does not press against the at least one outer surface in at least one second position of the plurality of positions for not cinching the at least one track portion between the grouser bar 1702 and the pressure plate 1708. Further, the traction device 1700 attaches to the at least one track portion in the at least one first position. Further, the traction device 1700 detaches from the at least one track portion in the at least one second position.

Further, in some embodiments, the track may include a plurality of tread blocks disposed on a track outer surface of the track in at least one tread pattern forming at least one valley. Further, the at least one valley may include the at least one track portion. Further, the grouser bar 1702 may be disposable on the at least one valley.

Further, in some embodiments, the at least one traction element 1722 may include at least one of at least one traction chain and at least one paddle bar. Further, the at least one of the at least one traction chain and the at least one paddle bar may be configured for providing at least one level of the traction for the track on the at least one surface.

Further, in some embodiments, the grouser bar 1702 may include at least one protrusion 1750 disposed on the bottom surface 1712. Further, the at least one protrusion 1750 configured for interfacing with the at least one outer surface of the at least one track portion based on the cinching of the at least one track portion between the grouser bar 1702 and the pressure plate 1708. Further, the at least one protrusion 1750 prevents at least one relative movement between the grouser bar 1702 and the at least one track portion based on the interfacing.

Further, in some embodiments, the pressure plate 1708 may include at least one first protrusion 1748 disposed on the superior surface 1746. Further, the at least one first protrusion 1748 configured for interfacing with the at least one inner surface of the at least one track portion based on the cinching of the at least one track portion between the grouser bar 1702 and the pressure plate 1708. Further, the at least one first protrusion 1748 prevents at least one relative movement between the pressure plate 1708 and the at least one track portion based on the interfacing.

Further, in some embodiments, the pressure plate 1708 may include at least one hollow cylinder 1740-1742 disposed on the inferior surface 1744. Further, the at least one hollow cylinder 1740-1742 may be configured for receiving a first portion of the at least one bolt 1728-1730 in an interior space of the at least one hollow cylinder 1740-1742 through an opening of the at least one hollow cylinder 1740-1742. Further, the first end 1736 of the at least one bolt 1728-1730 interfaces with the inferior surface 1744 based on the receiving.

Although the present disclosure has been explained in relation to its preferred embodiment, it is to be understood that many other possible modifications and variations can be made without departing from the spirit and scope of the disclosure.

What is claimed is:

1. A traction device for providing traction to a tracked vehicle, the traction device comprising:
a grouser bar disposable on at least one track portion of a track of the tracked vehicle, wherein the grouser bar comprises at least one traction element comprised in a top surface of the grouser bar, wherein the at least one traction element is configured to interface with at least one surface for providing traction for the track on the at least one surface, wherein a bottom surface of the grouser bar juxtaposes at least one outer surface of the at least one track portion, wherein the bottom surface opposes the top surface;
a down plate attached to the grouser bar, wherein a top edge of the down plate is attached to a butt end of the grouser bar, wherein the down plate extends over a side surface of the track along a depth of the track;
a bottom plate attached to the down plate, wherein a first edge of the bottom plate is attached to a bottom edge of the down plate, wherein the bottom plate is parallel to the grouser bar, wherein the bottom plate comprises at least one nut coaxially disposed around at least one hole comprised in the bottom plate;
a pressure plate movably disposed between the grouser bar and the bottom plate, wherein a superior surface of the pressure plate juxtaposes at least one inner surface of the at least one track portion; and
at least one bolt threadedly coupled to the at least one nut, wherein the at least one bolt is movably coupled with the pressure plate, wherein a first end of the at least one bolt interfaces with an inferior surface of the pressure plate, wherein the at least one bolt is configured for moving the pressure plate between a plurality of positions in relation to the bottom plate based on at least one action receivable on a second end of the at least one bolt, wherein the superior surface presses against the at least one inner surface and the bottom surface presses against the at least one outer surface in at least one first position of the plurality of positions for cinching the at least one track portion between the grouser bar and the pressure plate, wherein the superior surface does not press against the at least one inner surface and the bottom surface does not press against the at least one outer surface in at least one second position of the plurality of positions for not cinching the at least one track portion between the grouser bar and the pressure plate, wherein the traction device attaches to the at least one track portion in the at least one first position, wherein the traction device detaches from the at least one track portion in the at least one second position.

2. The traction device of claim 1, wherein the track comprises a plurality of tread blocks disposed on a track outer surface of the track in at least one tread pattern forming at least one valley, wherein the at least one valley comprises the at least one track portion, wherein the grouser bar is disposable on the at least one valley.

3. The traction device of claim 2, wherein the track outer surface forms the at least one outer surface of the at least one track portion based on the at least one tread pattern, wherein the plurality of tread blocks comprises a plurality of tread outer surfaces, wherein at least one tread outer surface of the plurality of tread outer surfaces interfaces with the at least one surface, wherein the at least one outer surface does not interface the at least one surface.

4. The traction device of claim 1, wherein the at least one traction element comprises at least one of at least one traction chain and at least one paddle bar, wherein the at least one of the at least one traction chain and the at least one paddle bar is configured for providing at least one level of the traction for the track on the at least one surface.

5. The traction device of claim 1, wherein the down plate is substantially perpendicular to at least one of the grouser bar and the bottom plate.

6. The traction device of claim 1, wherein the pressure plate is substantially parallel to at least one of the grouser bar and the bottom plate, wherein the pressure plate is substantially perpendicular to the down plate.

7. The traction device of claim 1, wherein the grouser bar comprises at least one protrusion disposed on the bottom surface, wherein the at least one protrusion configured for interfacing with the at least one outer surface of the at least one track portion based on the cinching of the at least one track portion between the grouser bar and the pressure plate, wherein the at least one protrusion prevents at least one relative movement between the grouser bar and the at least one track portion based on the interfacing.

8. The traction device of claim 1, wherein the pressure plate comprises at least one first protrusion disposed on the superior surface, wherein the at least one first protrusion configured for interfacing with the at least one inner surface of the at least one track portion based on the cinching of the at least one track portion between the grouser bar and the pressure plate, wherein the at least one first protrusion prevents at least one relative movement between the pressure plate and the at least one track portion based on the interfacing.

9. The traction device of claim 1, wherein the pressure plate comprises at least one hollow disposed on the inferior surface, wherein the at least one hollow cylinder is configured for receiving a first portion of the at least one bolt in an interior space of the at least one hollow cylinder through an opening of the at least one hollow cylinder, wherein the first end of the at least one bolt interfaces with the inferior surface based on the receiving.

10. The traction device of claim 9, wherein the pressure plate moves between the plurality of positions in at least one orientation in relation to at least one of the bottom plate and the grouser bar based on the receiving.

11. The traction device of claim 1, wherein the at least one bolt is configured for translationally moving along an axis perpendicular to at least one of the bottom plate and the grouser bar in relation to the bottom plate based on the at least one action receivable on the second end.

12. The traction device of claim 11, wherein the pressure plate moves between the plurality of positions along a first axis perpendicular to the pressure plate based on the translationally moving, wherein the first axis is parallel to the axis.

13. The traction device of claim 1, wherein the pressure plate is movably attached to a first side of the down plate, wherein the pressure plate moves between the plurality of positions along the down plate between the top edge and the bottom edge.

14. The traction device of claim 1, wherein the down plate is detachably attached to at least one of the grouser bar and the bottom plate using at least one attaching mechanism comprised in at least one of the top edge and the bottom edge, wherein the at least one attachment mechanism is configured for removably securing at least one of the butt end and the first edge.

15. A traction device for providing traction to a tracked vehicle, the traction device comprising:
a grouser bar disposable on at least one track portion of a track of the tracked vehicle, wherein the grouser bar comprises at least one traction element comprised in a top surface of the grouser bar, wherein the at least one traction element is configured to interface with at least one surface for providing traction for the track on the at least one surface, wherein a bottom surface of the grouser bar juxtaposes at least one outer surface of the at least one track portion, wherein the bottom surface opposes the top surface;
a down plate attached to the grouser bar, wherein a top edge of the down plate is attached to a butt end of the grouser bar, wherein the down plate extends over a side surface of the track along a depth of the track;
a bottom plate attached to the down plate, wherein a first edge of the bottom plate is attached to a bottom edge of the down plate, wherein the down plate is substantially perpendicular to at least one of the grouser bar and the bottom plate, wherein the bottom plate is parallel to the grouser bar, wherein the bottom plate comprises at least one nut coaxially disposed around at least one hole comprised in the bottom plate;
a pressure plate movably disposed between the grouser bar and the bottom plate, wherein a superior surface of the pressure plate juxtaposes at least one inner surface of the at least one track portion, wherein the pressure plate is substantially parallel to at least one of the grouser bar and the bottom plate, wherein the pressure plate is substantially perpendicular to the down plate; and
at least one bolt threadedly coupled to the at least one nut, wherein the at least one bolt is movably coupled with the pressure plate, wherein a first end of the at least one bolt interfaces with an inferior surface of the pressure plate, wherein the at least one bolt is configured for moving the pressure plate between a plurality of positions in relation to the bottom plate based on at least one action receivable on a second end of the at least one bolt, wherein the superior surface presses against the at least one inner surface and the bottom surface presses against the at least one outer surface in at least one first position of the plurality of positions for cinching the at least one track portion between the grouser bar and the pressure plate, wherein the superior surface does not press against the at least one inner surface and the bottom surface does not press against the at least one outer surface in at least one second position of the plurality of positions for not cinching the at least one track portion between the grouser bar and the pressure plate, wherein the traction device attaches to the at least one track portion in the at least one first position, wherein the traction device detaches from the at least one track portion in the at least one second position.

16. The traction device of claim 15, wherein the track comprises a plurality of tread blocks disposed on a track outer surface of the track in at least one tread pattern forming at least one valley, wherein the at least one valley comprises the at least one track portion, wherein the grouser bar is disposable on the at least one valley.

17. The traction device of claim 15, wherein the at least one traction element comprises at least one of at least one traction chain and at least one paddle bar, wherein the at least one of the at least one traction chain and the at least one paddle bar is configured for providing at least one level of the traction for the track on the at least one surface.

18. The traction device of claim 15, wherein the grouser bar comprises at least one protrusion disposed on the bottom surface, wherein the at least one protrusion configured for interfacing with the at least one outer surface of the at least one track portion based on the cinching of the at least one track portion between the grouser bar and the pressure plate, wherein the at least one protrusion prevents at least one relative movement between the grouser bar and the at least one track portion based on the interfacing.

19. The traction device of claim 15, wherein the pressure plate comprises at least one first protrusion disposed on the superior surface, wherein the at least one first protrusion configured for interfacing with the at least one inner surface of the at least one track portion based on the cinching of the at least one track portion between the grouser bar and the pressure plate, wherein the at least one first protrusion prevents at least one relative movement between the pressure plate and the at least one track portion based on the interfacing.

20. The traction device of claim 15, wherein the pressure plate comprises at least one hollow cylinder disposed on the inferior surface, wherein the at least one hollow cylinder is configured for receiving a first portion of the at least one bolt in an interior space of the at least one hollow cylinder through an opening of the at least one hollow cylinder, wherein the first end of the at least one bolt interfaces with the inferior surface based on the receiving.
